(19) United States
(12) Patent Application Publication
(10) Pub. No.: US 2026/0083243 A1
(43) Pub. Date: Mar. 26, 2026

(54) CONFIGURABLE DEVICE STAND

(71) Applicant: Lenovo (United States) Inc., Morrisville, NC (US)

(72) Inventor: Ghwang Hyun Lim, Cary, NC (US)

(21) Appl. No.: 18/897,943

(22) Filed: Sep. 26, 2024

(51) Int. Cl. A47B 97/00; F16M 11/04; F16M 11/06

(52) U.S. Cl. CPC A47B 97/00; F16M 11/041; F16M 11/06; A47B 2097/005; F16M 2200/06

(57) ABSTRACT

One embodiment provides a device stand, the device stand including: a first arm including a first pivot point; a second arm including a stand portion and a second pivot point; a connecting piece connected to one end of the first arm and one end of the second arm; and an attachment plate located near a second end of the first arm, wherein the attachment plate accepts an information handling device. Other aspects are claimed and described.

### BACKGROUND

With the increase in portable information handling devices (e.g., laptops, smart phones, tablets, smart watches, etc.), many of these devices are becoming increasingly lightweight and smaller. This provides less space for more traditional components, for example, covers, traditional displays, peripheral components, and/or the like. For example, many of these devices no longer have traditional keyboards and mice, but rather provide touch screens where the user provides input directly to the display portion of the device. While the decreases in the size and weight of the devices is useful when the devices are being used in a portable setting, for example, a user standing and holding the device to provide input, and/or the like, it can be a detriment when the device is used in a stationary setting, for example, being set on a desk or other surface where the user provides input to the device.

### BRIEF SUMMARY

In summary, one aspect provides a device stand, the device stand including: a first arm including a first pivot point; a second arm including a stand portion and a second pivot point; a connecting piece connected to one end of the first arm and one end of the second arm; and an attachment plate located near a second end of the first arm, wherein the attachment plate accepts an information handling device.

Another aspect provides a device stand, the device stand including: a first arm including a first pivot point; a second arm including a stand portion and a second pivot point, wherein the stand portion is configured to move about the second pivot point in a parallel rotation direction with respect to the second arm; a connecting piece connected via a first curved corner to one end of the first arm and connected via a second curved corner to one end of the second arm, wherein the connecting piece is perpendicular to the first arm and the second arm; and an attachment plate located near a second end of the first arm, wherein an edge of the attachment plate is on the same plane as the second end of the first arm, wherein the attachment plate accepts an information handling device, wherein the first pivot point is located on the first arm near the attachment plate, wherein the attachment plate is configured to move about the first pivot point in a parallel rotation direction with respect to the first arm.

A further aspect provides a device stand system, the device stand system including: a first information handling device; a second information handling device; and a device stand including: a first arm including a first pivot point; a second arm including a stand portion and a second pivot point; a connecting piece connected to one end of the first arm and one end of the second arm; and an attachment plate located near a second end of the first arm, wherein the attachment plate accepts the first information handling device, wherein the attachment plate couples to the second information handling device.

The foregoing is a summary and thus may contain simplifications, generalizations, and omissions of detail; consequently, those skilled in the art will appreciate that the summary is illustrative only and is not intended to be in any way limiting.

For a better understanding of the embodiments, together with other and further features and advantages thereof, reference is made to the following description, taken in conjunction with the accompanying drawings. The scope of the invention will be pointed out in the appended claims.

### BRIEF DESCRIPTION OF THE SEVERAL VIEWS OF THE DRAWINGS

FIG. 1 illustrates an example of information handling device circuitry.

FIG. 2 illustrates another example of information handling device circuitry.

FIG. 3A illustrates an example front view of a configurable device stand that accepts a first information handling device and that touches a second information handling device.

FIG. 3B illustrates an example back view of a configurable device stand that accepts a first information handling device and that touches a second information handling device.

FIG. 4 illustrates views illustrating a reconfiguration of the configurable device stand from a left mode device stand to a right mode device stand.

FIG. 5A illustrates an example of the configurable device stand in a stand configuration.

FIG. 5B illustrates an example of the configurable device stand in a sketch configuration.

FIG. 5C illustrates an example of the configurable device stand in a flat configuration.

FIG. 6 illustrates an example of the configurable device stand in a flat configuration being carried.

### DETAILED DESCRIPTION

One of the problems with the portable devices is that while they are very usable in a portable setting, the things that make them very portable are drawbacks when the device is used in a stationary setting. For example, many portable devices does not include stands or something that can be used to prop the device up so it is more visible for the user when used in a stationary setting. The lack of stand in a portable setting is fine because the device is not stationary. Thus, the removal of the stand reduces the weight of the device, making it easier to hold and utilize for longer periods of time. However, when the user wants to use the device on a surface in a stationary manner, the device can only lie on the surface. This means that the user has to lean over the device which results in poor posture and ergonomics, which, if the user utilizes the device in this manner for long periods of time, can result in pain to the user.

One technique that users use to change the position of the device is to use some other object, such as another device, a book, a piece of clothing, and/or the like, to prop the device into a desired position. However, devices frequently slip or fall when another object is used to prop the device. Additionally, using another object does not allow much flexibility on how the device is positioned. In other words, once a user gets the device to stay propped with the object, the position of the device cannot change and it may not be the most desirable position for the device. Additionally, if the device is being used in conjunction with another device, this propping does not allow the device to be positioned to be the most conducive for use with the other device.

Some device stands exist that allow for holding a device without an integrated stand. While these device stands may position a device to be utilized with another device, these device stands are designed to sit on surface. In other words, they are not very portable. Thus, they could not be carried with the device if desired. Additionally, these device stands are generally designed to be used on a single side of the second device. Thus, if a user wants to move the device to the other side of the second device (e.g., from right side to left side or vice versa), the device stand may interfere with the ability of the user to put the device next to or touching the second device. In other words, while the device stand may allow for the device to be touching the second device on one side of the second device, it does not provide the same functionality on the other side of the second device.

Accordingly, the described system provides a device stand that includes a first arm and a second arm. The first arm and the second arm are connected with a connecting piece that is connected to one end of the first arm and one end of the second arm. The connecting piece is perpendicular to the first arm and the second arm. The first arm and the second arm are parallel to each other. Accordingly, the first arm, second arm, and connecting piece make a roughly U-shape, with the connecting piece being the bottom part of a flat bottomed U, and the first arm and second arm being the stems of the U. The second arm also includes a stand portion. The stand portion runs perpendicular to the second arm to create a base that holds the device stand up when it is so configured to sit on a surface.

To configure the device stand in different configurations, the first arm and the second arm include a first pivot point and a second pivot point, respectively. The first arm also includes an attachment plate that is located near a second end of the first arm. The pivot point of the first arm is located near this attachment plate and allows the attachment plate to rotate in a parallel rotation direction with respect to the first arm. In other words, the attachment plate can rotate around the first arm like a helicopter blade. The attachment plate is designed to accept an information handling device. The information handling device may attach to the attachment plate via the use of an attachment mechanism. Additionally, the attachment plate may connect to a second information handling device using an attachment mechanism. This allows the information handling device attached to the attachment plate to touch the second information handling device, if desired by the user.

The pivot point of the second arm allows rotation of the stand portion of the second arm. This allows the stand portion to rotate in a parallel rotation direction with respect to the second arm, thereby allowing the user to turn the stand portion so that it no longer provides a base that holds the device stand up, but rather allows the stand portion to run parallel to the connecting piece. Thus, these two pivot points allow a user to reconfigure the stand from a device stand having a base that holds the device stand in a stand configuration to a flat configuration that allows the device stand to be flat for storage or carrying.

Thus, the described device stand provides an improvement over traditional device stands. The described device stand allows the device stand to be reconfigured into different configurations that are more conducive for performing different functions, instead of traditional device stands that are generally only able to be configured in one or two configurations. Additionally, the described device stand allows for the device stand to be utilized on either the left side or the right side of a display or other information handling device without resulting in a gap between the device located on the stand and the display or other information handling device. This is in contrast to traditional device stands that can be moved to either side of the display, but result in parts of the stand interfering with the device on the stand and the display, thereby resulting in a configuration that does not allow the device and the display to touch. Finally, the described device stand provides for connection mechanisms that allow the device stand to be utilized with a device and does not require additional wires or connections to be run between the device and the display. Such functionality is not provided with traditional device stands. Thus, the described device stand provides for greater user configurability, greater usability, and greater portability as compared to traditional device stands.

The illustrated example embodiments will be best understood by reference to the figures. The following description is intended only by way of example, and simply illustrates certain example embodiments.

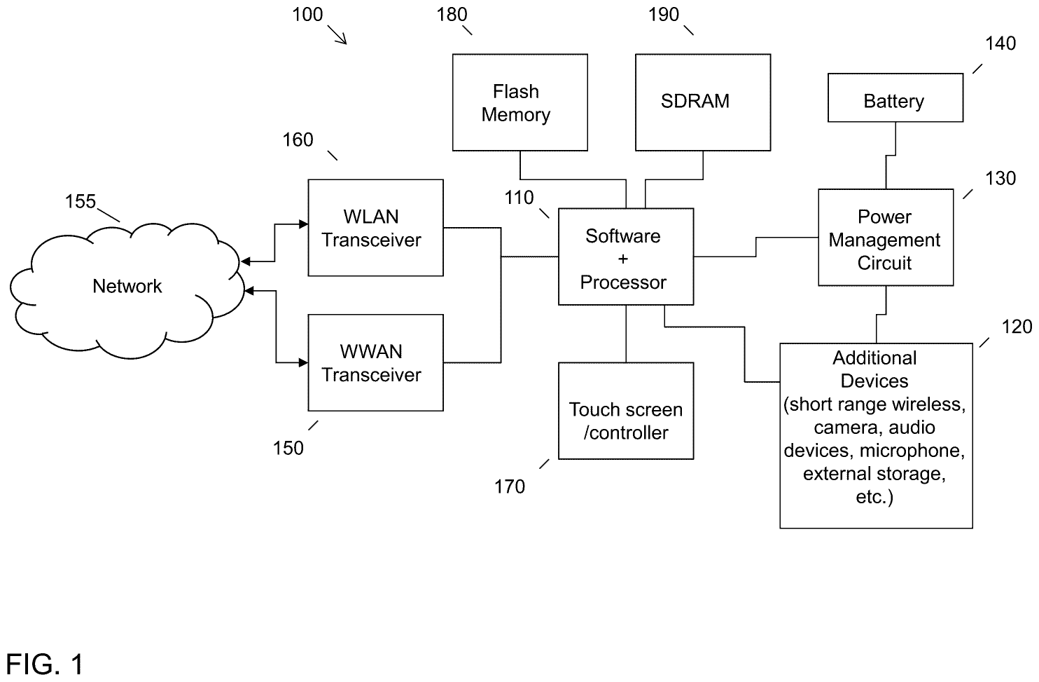

While various other circuits, circuitry or components may be utilized in information handling devices, with regard to smart phone and/or tablet circuitry 100, an example illustrated in FIG. 1 includes a system on a chip design found for example in tablet or other mobile computing platforms. Software and processor(s) are combined in a single chip 110. Processors comprise internal arithmetic units, registers, cache memory, busses, input/output (I/O) ports, etc., as is well known in the art. Internal busses and the like depend on different vendors, but essentially all the peripheral devices (120) may attach to a single chip 110. The circuitry 100 combines the processor, memory control, and I/O controller hub all into a single chip 110. Also, systems 100 of this type do not typically use serial advanced technology attachment (SATA) or peripheral component interconnect (PCI) or low pin count (LPC). Common interfaces, for example, include secure digital input/output (SDIO) and inter-integrated circuit (I2C).

There are power management chip(s) 130, e.g., a battery management unit, BMU, which manage power as supplied, for example, via a rechargeable battery 140, which may be recharged by a connection to a power source (not shown). In at least one design, a single chip, such as 110, is used to supply basic input/output system (BIOS) like functionality and dynamic random-access memory (DRAM) memory.

System 100 typically includes one or more of a wireless wide area network (WWAN) transceiver 150 and a wireless local area network (WLAN) transceiver 160 for connecting to various networks 155 (e.g., telecommunications networks, wireless Internet devices (e.g., access points), cloud networks, remote networks, local networks, etc.). Additionally, devices 120 are commonly included, e.g., a wireless communication device, external storage, camera, microphone, external storage, etc. System 100 often includes a touch screen 170 for data input and display/rendering. System 100 also typically includes various memory devices, for example flash memory 180 and synchronous dynamic random-access memory (SDRAM) 190.

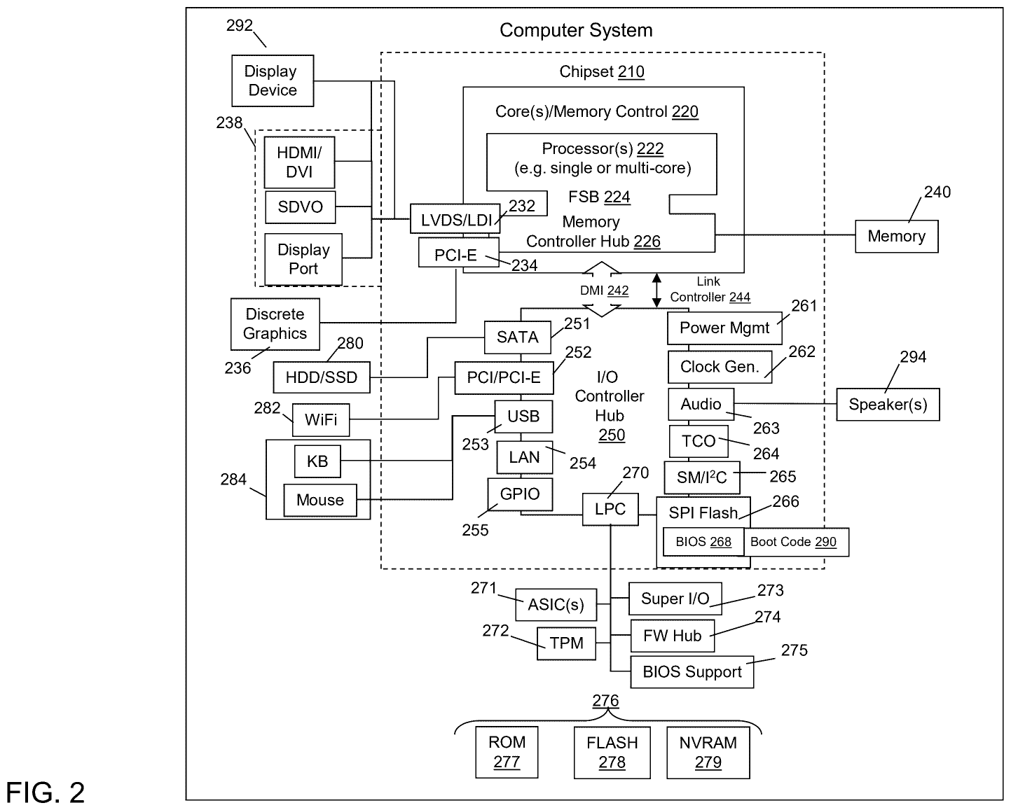

FIG. 2 depicts a block diagram of another example of information handling device circuits, circuitry, or components. The example depicted in FIG. 2 may correspond to computing systems such as personal computers, or other devices. As is apparent from the description herein, embodiments may include other features or only some of the features of the example illustrated in FIG. 2.

The example of FIG. 2 includes a so-called chipset 210 (a group of integrated circuits, or chips, that work together, chipsets) with an architecture that may vary depending on manufacturer. The architecture of the chipset 210 includes a core and memory control group 220 and an I/O controller hub 250 that exchanges information (for example, data, signals, commands, etc.) via a direct management interface (DMI) 242 or a link controller 244. In FIG. 2, the DMI 242 is a chip-to-chip interface (sometimes referred to as being a link between a “northbridge” and a “southbridge”). The core and memory control group 220 include one or more processors 222 (for example, single or multi-core) and a memory controller hub 226 that exchange information via a front side bus (FSB) 224; noting that components of the group 220 may be integrated in a chip that supplants the conventional “northbridge” style architecture. One or more processors 222 comprise internal arithmetic units, registers, cache memory, busses, I/O ports, etc., as is well known in the art.

In FIG. 2, the memory controller hub 226 interfaces with memory 240 (for example, to provide support for a type of random-access memory (RAM) that may be referred to as “system memory” or “memory”). The memory controller hub 226 further includes a low voltage differential signaling (LVDS) interface 232 for a display device 292 (for example, a cathode-ray tube (CRT), a flat panel, touch screen, etc.). A block 238 includes some technologies that may be supported via the low-voltage differential signaling (LVDS) interface 232 (for example, serial digital video, high-definition multimedia interface/digital visual interface (HDMI/DVI), display port). The memory controller hub 226 also includes a PCI-express interface (PCI-E) 234 that may support discrete graphics 236.

In FIG. 2, the I/O hub controller 250 includes a SATA interface 251 (for example, for hard-disc drives (HDDs), solid-state drives (SSDs), etc., 280), a PCI-E interface 252 (for example, for wireless connections 282), a universal serial bus (USB) interface 253 (for example, for devices 284 such as a digitizer, keyboard, mice, cameras, phones, microphones, storage, other connected devices, etc.), a network interface 254 (for example, local area network (LAN)), a general purpose I/O (GPIO) interface 255, a LPC interface 270 (for application-specific integrated circuit (ASICs) 271, a trusted platform module (TPM) 272, a super I/O 273, a firmware hub 274, BIOS support 275 as well as various types of memory 276 such as read-only memory (ROM) 277, Flash 278, and non-volatile RAM (NVRAM) 279), a power management interface 261, a clock generator interface 262, an audio interface 263 (for example, for speakers 294), a time controlled operations (TCO) interface 264, a system management bus interface 265, and serial peripheral interface (SPI) Flash 266, which can include BIOS 268 and boot code 290. The I/O hub controller 250 may include gigabit Ethernet support.

The system, upon power on, may be configured to execute boot code 290 for the BIOS 268, as stored within the SPI Flash 266, and thereafter processes data under the control of one or more operating systems and application software (for example, stored in system memory 240). An operating system may be stored in any of a variety of locations and accessed, for example, according to instructions of the BIOS 268. As described herein, a device may include fewer or more features than shown in the system of FIG. 2.

Information handling device circuitry, as for example outlined in FIG. 1 or FIG. 2, may be used in devices such as tablets, smart phones, personal computer devices generally, and/or electronic devices, which may include or utilize device stands as described herein. For example, the circuitry outlined in FIG. 1 may be implemented in a tablet or smart phone embodiment, whereas the circuitry outlined in FIG. 2 may be implemented in a personal computer embodiment.

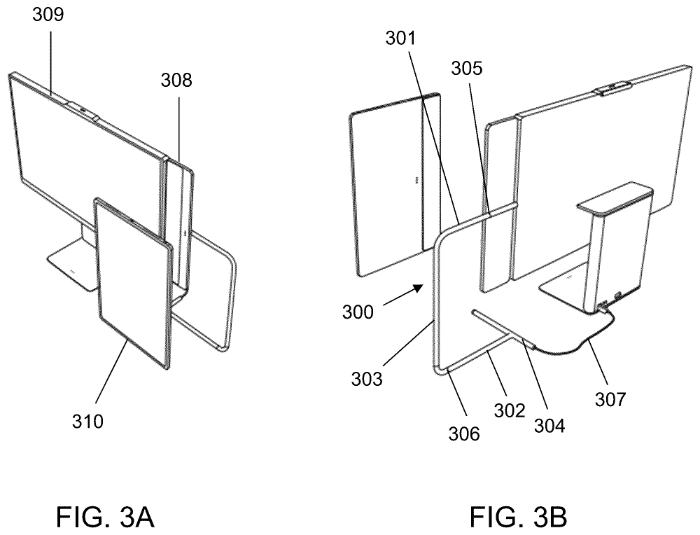

FIG. 3A illustrates a front view of the described device stand 300 next to a second information handling device and before the information handling device is attached to the stand. FIG. 3B illustrates the back view of the same. For ease of readability, the second information handling device will be referred to as a display and the information handling device will be referred to as a tablet. However, these are intended to be non-limiting as any information handling device can be utilized for either the information handling device or the second information handling device, for example, a laptop computer, a smart monitor, a display, a tablet, a personal computing system, a smart television, a television, a smart appliance, and/or the like. Additionally, for ease of readability, the information handling device will be the device that is being attached to the device stand or that is being supported by the device stand. The second information handling device will be the device that the device stand is being placed next to or that the device attached to the device stand is being used in conjunction with.

The device stand 300 includes a first arm 301 and a second arm 302. The first arm 301 and the second arm 302 are parallel to each other and connected by a connecting piece 303. The connecting piece 303 is connected to an end of the first arm 301 and an end of the second arm 302. The connecting piece 303 may be perpendicular to the first arm 301 and the second arm 302. Thus, the connecting piece 303, first arm 301, and second arm 302, may form a U-type shape, where the connecting piece 303 is the bottom part of a flat-bottomed U and the first arm 301 and the second arm 302 are the stem portions of the U. The connecting piece 303, first arm 301 without the attachment plate 308, and second arm 302 without the stand portion 304, may all be in the same plane. In other words, the connecting piece 303, first arm 301 without the attachment plate 308, and second arm 302 without the stand portion 304, may not protrude with respect to one another.

The connecting piece 303 may connect to the first arm 301 and the second arm 302 via curved corners. However, this is not strictly necessary and may only be for aesthetic or safety reasons. For example, the connecting piece 303 could connect to the first arm 301 and the second arm 302 via sharp 90° corners, diagonal pieces, irregular shapes, and/or the like. Additionally, the use of curved corners or other smoother shaped corners may facilitate the running of wires or cables through the device stand 300, as discussed in more detail below. However, as previously mentioned, this is not strictly necessary. The connecting piece 303 may also have portions that extend past the first arm 301 and/or the second arm 302. In other words, the first arm 301 and/or second arm 302

The second arm 302 may include a stand portion 304. The stand portion 304 may include two legs portions that are opposing sides of the second arm 302. The leg portions of the stand portion 304 may be linear with respect to each other, meaning they are in a straight line. However, other configurations are contemplated and possible, for example, the legs may be angled with respect to one another, one leg may be straight whereas the other leg is angled, the legs may have wavy shapes, the legs may create a circular or curved shape, and/or the like. Illustrated in FIG. 3B, one of the leg portions may be longer than the other leg portion. However, the legs may also be the same length.

The stand portion 304 is illustrated as being at the opposing end of the second arm 302 as compared to the connecting piece 303. Thus, the stand portion 304 may be at a second end of the second arm 302, where the second end is opposite the end where the connecting piece 303 connects to the second arm 302. However, the stand portion 304 could be located at a different location on the second arm 302, for example, in the middle, closer to the connecting piece 303, and/or the like. Additionally, each of the legs of the stand portion 304 could be located at different locations on the second arm 302. For example, one leg portion could be located at the end of the second arm 302, as illustrated, and the other leg portion could be located towards the middle of the second arm 302.

The first arm 301 may include an attachment plate 308 that is located near a second end of the first arm 301. The attachment plate 308 may be located on the first arm 301 so that an edge of the attachment plate 308 is on the same plane as the second end of the first arm 301. In other words, the attachment plate 308 may be located so that the end of the first arm 301 and the edge of the attachment plate 308 create a flat surface therebetween. Alternatively, the attachment plate 308 may extend past the second end of the first arm 301. The attachment plate 308 may accept an information handling device 310, with the example being a tablet device. Thus, the attachment plate 308 may include attachment mechanisms to hold the tablet. Illustrated in FIG. 3 is an attachment plate 308 shaped as a long rectangular bar. This attachment plate 308 includes magnets that interface with magnets on the tablet. Thus, in this example, the attachment mechanisms are magnets that hold the tablet to the device stand.

However, other attachment mechanisms or a combination of attachment mechanisms may be utilized. For example, the attachment plate could include a ledge that the tablet is set upon. As another example, the attachment plate could include holders or hands that wrap around an edge of the tablet to hold the tablet to the attachment plate. As a final, non-limiting example, the attachment plate could include fastening mechanisms (e.g., hook and loop fasteners, sticky substances, latches and receptacles, pins and holes, and/or the like) that can hold the tablet to the attachment plate. These are intended as non-limiting examples and other attachment mechanisms are contemplated and possible. Additionally, the attachment plate may include a combination of attachment mechanisms. Additionally, the types of possible attachment mechanisms can change based upon a shape and size of the attachment plate 308. For example, a larger attachment plate may have more possible attachment mechanisms than a smaller attachment plate. As another example, an attachment plate having a different shape may allow for different locations of attachment mechanisms.

Additionally, the attachment plate 308 may include connectors that allow for electrical connection between the tablet and the attachment plate 308. For example, the attachment plate 308 may include a pogo pin connector, a universal serial bus (USB) connector, a power connector, a data transfer connector, and/or the like, located on the attachment plate 308 in a location which corresponds to a location of a corresponding connector of the tablet. Since different devices may have connectors located in different positions, the connector on the attachment plate 308 may be moveable or the position of the connector may be otherwise modifiable so as to align with the connector of the table or other device. For example, the connector may be located on a movable tab that a user can correctly position, the connector may be located on a movable switch that a user can correctly position, the connector may be located at an edge (bottom, top, left edge, right edge, etc.) of the attachment plate with a wire or other cable that allows the user to plug it into the device, and/or the like.

Additionally, or alternatively, the attachment plate 308 may include one or more electronic components that can communicate with the tablet for information transfer purposes, power transfer purposes, and/or the like. For example, the attachment plate 308 could include one or more wireless communication mechanisms (e.g., near-field communication mechanisms, short-range wireless communication mechanisms, network communication mechanisms, etc.) that facilitate data transfer between the tablet and the attachment plate 308. As another example, the attachment plate 308 may include a charging plate or mechanism that can be used to charge a battery of the tablet, either via wireless charging or wired charging with the inclusion of connectors in the attachment plate 308.

Additionally, or alternatively, the attachment plate 308 could be movable along the first arm 301 or could be removable from the first arm 301. A movable attachment plate 308 would allow the user to move the attachment plate along the first arm 301 so as to assist in either lining up the connectors of the attachment plate 308 and tablet, or to move the tablet to a different location on the device stand 300, if desired. A removable attachment plate 308 may allow for the user to switch attachment plates 308, for example, if there are multiple attachment plates that could be utilized with the device stand. Having multiple attachment plates could allow for unique attachment plates for different devices which may have connectors located in a specific location for the designed device. Multiple attachment plates could also include a generic plate. Additionally, different attachment plates could have different features, for example, while some attachment plates may include magnets for holding the device onto the attachment plate, other attachment plates may include a ledge for holding the device. As another example, different attachment plates could have different shapes or configurations. By allowing for the attachment plate 308 to be removable, the user could utilize an attachment plate of their choosing.

The size and shape of the attachment plate 308 may be different than what is illustrated in the figures. Additionally, the attachment plate 308 may have additional features. For example, the attachment plate 308 may include features that allow a size and/or shape of the attachment plate 308 to be changed. For example, the attachment plate may include two layers that are stacked on top of each other and held together using a center screw, pin, bolt, and/or the like. Thus, the two layers can move with respect to one other. This could allow the layers to be configured into different shapes, for example, an X-shape, a t-shape, a T-shape, an upside down-T shape, and/or the like. This may allow for the attachment of different devices to the attachment plate. As another example, the attachment plate could have openings that allow the layers to move up and down with respect to one other, to facilitate the configuration of the attachment plate into the different shapes. As another example, the legs of the attachment plate may include extenders which allow the length or size of the legs to be increased or decreased to facilitate different shapes and sizes.

The attachment plate 308 may also have another feature which allows the attachment plate 308 to connect to the second information handling device 309, with the example being a display. Thus, instead of simply being moved to touch the display, the attachment plate 308 could include attachment mechanisms along or within the edge that facilitate connection of the attachment plate 308 to the display. This attachment mechanism may ensure that the device stand does not accidentally move when a user does not want it to, for example, if the surface were bumped, jarred, vibrated, or otherwise moved. The attachment mechanism may be magnets that can interface with a material of the display or that interface with magnets that may be included in the display.

The attachment mechanism may, alternatively, be any of the previously discussed attachment mechanisms, different attachment mechanism, or a combination of attachment mechanisms. For example, since the device stand/attachment plate and display sit next to each other, attachment mechanisms that span across the back (or front) of the attachment plate and display are possible. For example, both the attachment plate or device stand and the display could have protrusions that a loop or other material is wrapped around to hold the two parts together. As another example, a single attachment mechanism could span across the two parts, for example, tape, a reusable sticker, and/or the like. Other attachment mechanisms are contemplated and possible.

Since the attachment plate 308 may include connectors or other electronic components, the device stand 300 may include wires or cables 307 that connect to the connectors or electronic components of the attachment plate 308 to a location outside the device stand 300. While the device stand 300 may include components that can facilitate the transfer of information or power from the tablet to the display wirelessly or vice versa, it may be beneficial to utilize a wired connection to transfer the information or power. Thus, the device stand 300 may include wires or cables 307 that have a connector at a location external to the device stand 300. This connector could then be plugged into the display. Thus, the information and power transfer can be facilitated through the wires or cables 307. In other words, the wires or cables 307 can provide an electrical connection from the tablet via the attachment plate to the display utilizing a device connector located at an end of the wire external to the device stand 300.

In order to reduce the number of wires or cables 307, a portion of the wires or cables 307 may be within the device stand 300. For example, the wires or cables 307 may enter the device stand 300 from a location at or near the attachment plate 308. The wires or cables 307 may then follow the shape of the device stand 302 to another location of the device stand 300 where it may exit the device stand 300. As illustrated in FIG. 3B, the wires and cables 307 enter the device stand 300 near the attachment plate 308 are run through the first arm 301, connecting piece 303, second arm 302, and a leg of the stand portion 304. The wires and cables 307 then exit the leg of the stand portion 304 and terminates in a connector that is connected to the display 309.

Accordingly, the device stand 300 may be hollow. Thus, the device stand 300 may be constructed from hollow tubing, piping, hollow structural structures, or some other hollow material. The material of the device stand may be metal, plastic, wood, and/or the like, or a combination thereof. The device stand may also be made of a combination of materials. For example, the structure or body of the device stand (e.g., the first arm 301, second arm 302, connecting piece 303, etc.), may be made of a metal or plastic materials, whereas the attachment plate may be made of a plastic material. Additionally, different components may be made of different materials depending on the components. For example, the electrical connectors may be made of a metal that is conducive for conductivity, whereas the rest of the attachment plate is made of a plastic material. As should be understood, the materials can be any type of materials, and these are merely illustrative examples.

A configuration of the device stand 300 can be modified utilizing a first pivot point 305 located on the first arm 301 and a second pivot point 306 located on the second arm 302. A different number of pivot points could be included, for example, fewer than two, greater than two, and/or the like. The pivot points may be made of different components that allow for the pivot or rotation of one piece connected via the pivot point with respect to another piece connected via the pivot point. Example pivot point components include, but are not limited to, hinges, rotary connectors, slip rings, swivels, bearings, pins, pivot shafts, and/or the like. Additionally, the pivot points may include parts that stop the pieces from rotating with respect to each other unless a force is applied to make them rotate, for example, a friction connection, teeth, and/or the like.

The first pivot point 305 may be located anywhere on the first arm 301. For example, the first pivot point 305 may be located near the attachment plate 308, located near the end where the connecting piece 303 connects to the first arm 301, and/or the like. However, the first pivot point 305 will be located on the first arm 301 between the attachment plate 308 and the connecting piece 303. The first pivot point 305 allows the attachment plate 308 to move about the first pivot point 305 in a parallel rotation direction with respect to the first arm 301. In other words, the attachment plate 308 (and possibly part of the first arm 301, depending on the location of the first pivot point 305 on the first arm 301) can be rotated around the first arm 301, similar to a helicopter blade. While the first pivot point 305 may allow for 360° rotation of the attachment plate 308, the first pivot point 305 may also allow for rotation less than 360°.

The second pivot point 306 may be located anywhere on the second arm 302. For example, the second pivot point 306 may be located near the end of the second arm 302 connected to the connecting piece 303, located near the end near the stand portion 304, and/or the like. The second pivot point 306 allows for the stand portion 304 to move about the second pivot point 306 in a parallel rotation direction with respect to the second arm 302. In other words, the stand portion 304 (and possibly part of the second arm 302, depending on the location of the second pivot point 306 on the second arm 302) can be rotate around the second arm 302, similar to a helicopter blade. While the second pivot point 306 may allow for 360° rotation of the stand portion 304, the second pivot point 306 may also allow for rotation less than 360°.

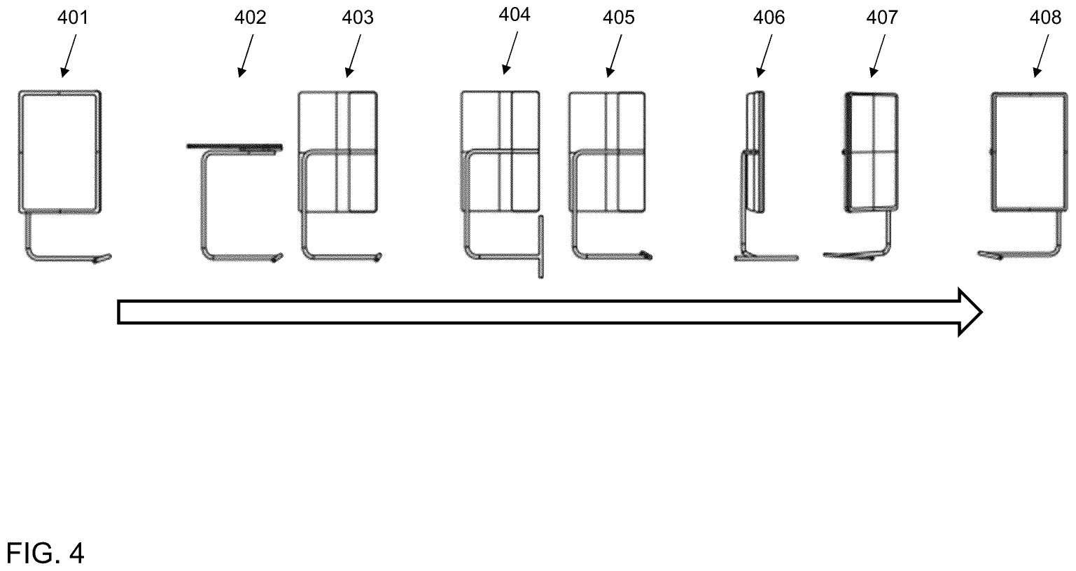

The ability of the attachment plate 308 and stand portion 304 via the first pivot point 305 and second pivot point 306, respectively, is what allows the device stand 300 to be reconfigured to different configurations or modes. For example, the device stand 300 can be reconfigured from a left mode device stand to a right mode device stand. The reconfiguration of the device stand 300 from a left mode stand to a right mode stand is illustrated in FIG. 4. A left mode stand refers to the fact that the attachment plate 308 is located on the right side of the device stand 300 when the display of the tablet is facing the user. This configuration would be useful for when the tablet is being used on the left side of the display and would allow for the right edge of the tablet to touch the left edge of the display with no air gap (if desired) between the tablet and display. The right mode stand refers to the fact that the attachment plate 308 is located on the left side of the device stand 300 when the display of the tablet is facing the user. This configuration would be useful for when the tablet is being used on the right side of the display and would allow for the left edge of the tablet to touch the right edge of the display with no air gap (if desired) between the tablet and display.

At 401 in FIG. 4, the device stand has a tablet attached to it and is configured in the left mode stand configuration. At 402, the tablet has been rotated 90° via the first pivot point 305 of the first arm 301. At 403, the tablet has been rotated 180° via the first pivot point 305 of the first arm 301. The back of the tablet is now facing towards the user, with the rest of the device stand 300 remaining in the previous configuration. At 404, the stand portion 304 has been rotated 90° via the second pivot point 306 of the second arm 302. At 405, the stand portion 304 has been rotated 180° via the second pivot point 306 of the second arm 302. It should be noted that this step is not strictly necessary. However, if the device stand 300 includes a wire or cable 307 that runs through the device stand 300, this step allows the wire or cable 307 to be located towards the back of the device stand 300 when the device stand 300 is configured in the right mode stand configuration.

At 406 the entire device stand 300, including the tablet, is partially rotated. At 407, the device stand 300 is continuing to be rotated, until the device stand has been rotated 180° so that the display of the tablet is now facing the user again at 408. As can be seen at 408, the device stand 300 is now in a right mode stand configuration useful for use on the right side of the display. Additionally, if equipped, the wires and cables 307 would exit out of the device stand 300 at the back of the device stand 300.

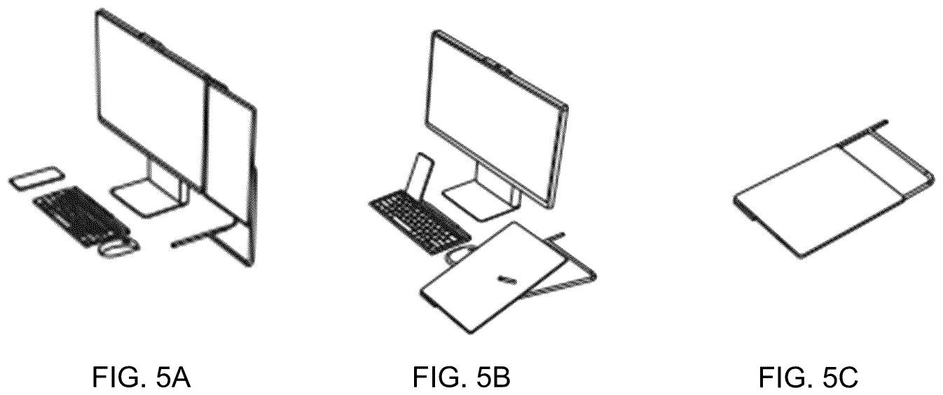

FIG. 5A, FIG. 5B, and FIG. 5C illustrate different configurations of the device stand that are possible using the multiple pivot points. FIG. 5A illustrates the device stand in a stand configuration. The stand configuration may be useful when the tablet is placed next to a display so that the tablet can be used in conjunction with the display and positioned to match or be similar to the positioning of the display. FIG. 5B illustrates the device stand in a sketch configuration. In this configuration, the connecting piece has been moved to be flat with the second arm. The attachment plate, however, is rotated so that it is not flat with the connecting piece, but is slightly rotated as to allow the display of the tablet to be slightly elevated from the surface that the device stand is located upon. This provides a useful angle for providing drawing or sketching input onto the display of the tablet.

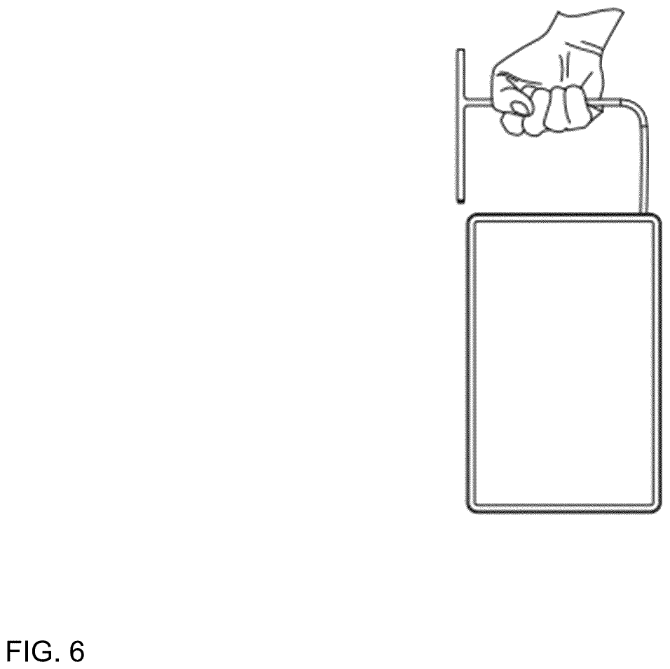

FIG. 5C illustrates the device stand in a flat configuration. In this configuration, the second arm, connecting piece, first arm, and attachment plate are all flat with respect to each other, thereby providing as flat of a device stand as possible. This configuration may be useful when the user wants the tablet to be flat on a surface but does not want to remove the tablet from the device stand. This flat mode is also useful for carrying the device and/or device stand as illustrated in FIG. 6. It should be understood that the configurations illustrated in all the figures are merely illustrative of the possible configurations and other configurations are possible via use of the pivot points.

It will be readily understood that the components of the embodiments, as generally described and illustrated in the figures herein, may be arranged and designed in a wide variety of different configurations in addition to the described example embodiments. Thus, the more detailed description of the example embodiments, as represented in the figures, is not intended to limit the scope of the embodiments, as claimed, but is merely representative of example embodiments.

Reference throughout this specification to “one embodiment” or “an embodiment” (or the like) means that a particular feature, structure, or characteristic described in connection with the embodiment is included in at least one embodiment. Thus, the appearance of the phrases “in one embodiment” or “in an embodiment” or the like in various places throughout this specification are not necessarily all referring to the same embodiment.

Furthermore, the described features, structures, or characteristics may be combined in any suitable manner in one or more embodiments. In the description, numerous specific details are provided to give a thorough understanding of embodiments. One skilled in the relevant art will recognize, however, that the various embodiments can be practiced without one or more of the specific details, or with other methods, components, materials, et cetera. In other instances, well known structures, materials, or operations are not shown or described in detail to avoid obfuscation.

As will be appreciated by one skilled in the art, various aspects may be embodied as a system, method, or device program product. Accordingly, aspects may take the form of an entirely hardware embodiment or an embodiment including software that may all generally be referred to herein as a “circuit,” “module” or “system.” Furthermore, aspects may take the form of a device program product embodied in one or more device readable medium(s) having device readable program code embodied therewith.

It should be noted that the various functions described herein may be implemented using instructions stored on a device readable storage medium such as a non-signal storage device that are executed by a processor. A storage device may be, for example, an electronic, magnetic, optical, electromagnetic, infrared, or semiconductor system, apparatus, or device, or any suitable combination of the foregoing. More specific examples of a storage medium would include the following: a portable computer diskette, a hard disk, a random-access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a storage device is not a signal and is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire. Additionally, the term “non-transitory” includes all media except signal media.

Program code embodied on a storage medium may be transmitted using any appropriate medium, including but not limited to wireless, wireline, optical fiber cable, radio frequency, et cetera, or any suitable combination of the foregoing.

Program code for carrying out operations may be written in any combination of one or more programming languages. The program code may execute entirely on a single device, partly on a single device, as a stand-alone software package, partly on single device and partly on another device, or entirely on the other device. In some cases, the devices may be connected through any type of connection or network, including a local area network (LAN) or a wide area network (WAN), or the connection may be made through other devices (for example, through the Internet using an Internet Service Provider), through wireless connections, e.g., near-field communication, or through a hard wire connection, such as over a USB connection.

Example embodiments are described herein with reference to the figures, which illustrate example methods, devices, and program products according to various example embodiments. It will be understood that the actions and functionality may be implemented at least in part by program instructions. These program instructions may be provided to a processor of a device, a special purpose information handling device, or other programmable data processing device to produce a machine, such that the instructions, which execute via a processor of the device implement the functions/acts specified.

It is worth noting that while specific blocks are used in the figures, and a particular ordering of blocks has been illustrated, these are non-limiting examples. In certain contexts, two or more blocks may be combined, a block may be split into two or more blocks, or certain blocks may be re-ordered or re-organized as appropriate, as the explicit illustrated examples are used only for descriptive purposes and are not to be construed as limiting.

As used herein, the singular “a” and “an” may be construed as including the plural “one or more”unless clearly indicated otherwise.

This disclosure has been presented for purposes of illustration and description but is not intended to be exhaustive or limiting. Many modifications and variations will be apparent to those of ordinary skill in the art. The example embodiments were chosen and described in order to explain principles and practical application, and to enable others of ordinary skill in the art to understand the disclosure for various embodiments with various modifications as are suited to the particular use contemplated.

Thus, although illustrative example embodiments have been described herein with reference to the accompanying figures, it is to be understood that this description is not limiting and that various other changes and modifications may be affected therein by one skilled in the art without departing from the scope or spirit of the disclosure.

What is claimed is:

1. A device stand, the device stand comprising:
a first arm comprising a first pivot point;
a second arm comprising a stand portion and a second pivot point;
a connecting piece connected to one end of the first arm and one end of the second arm; and
an attachment plate located near a second end of the first arm, wherein the attachment plate accepts an information handling device.

2. The device stand of claim 1, wherein the connecting piece is perpendicular to the first arm and the second arm.

3. The device stand of claim 1, wherein the first arm is parallel to the second arm.

4. The device stand of claim 1, wherein the stand portion comprises two leg portions on opposing sides of the second arm.

5. The device stand of claim 4, wherein the two leg portions are linear with respect to one another.

6. The device stand of claim 1, wherein the device stand is constructed from hollow tubing.

7. The device stand of claim 6, further comprising wires located within the device stand and providing an electrical connection from the attachment plate to a device connector located at one end of the wire external to the device stand.

8. The device stand of claim 1, wherein the attachment plate couples to a second information handling device.

9. The device stand of claim 1, wherein the attachment plate comprises magnets to connect to the information handling device.

10. The device stand of claim 1, a configuration of the device stand is modifiable utilizing at least one of: the first pivot point and the second pivot point.

11. The device stand of claim 1, wherein the first pivot point is located on the first arm near the attachment plate, wherein the attachment plate is configured to move about the first pivot point in a parallel rotation direction with respect to the first arm.

12. The device stand of claim 1, wherein the stand portion is configured to move about the second pivot point in a parallel rotation direction with respect to the second arm.

13. A device stand, the device stand comprising:
a first arm comprising a first pivot point;
a second arm comprising a stand portion and a second pivot point, wherein the stand portion is configured to move about the second pivot point in a parallel rotation direction with respect to the second arm;
a connecting piece connected via a first curved corner to one end of the first arm and connected via a second curved corner to one end of the second arm, wherein the connecting piece is perpendicular to the first arm and the second arm; and
an attachment plate located near a second end of the first arm, wherein an edge of the attachment plate is on the same plane as the second end of the first arm, wherein the attachment plate accepts an information handling device, wherein the first pivot point is located on the first arm near the attachment plate, wherein the attachment plate is configured to move about the first pivot point in a parallel rotation direction with respect to the first arm.

14. The device stand of claim 13, wherein the first arm is parallel to the second arm.

15. The device stand of claim 13, wherein the stand portion comprises two leg portions on opposing sides of the second arm, wherein the two leg portions are linear with respect to one another.

16. The device stand of claim 13, wherein the device stand is constructed from hollow tubing.

17. The device stand of claim 16, further comprising wires located within the device stand and providing an electrical connection from the attachment plate to a device connector located at one end of the wire external to the device stand.

18. The device stand of claim 13, wherein the attachment plate couples to a second information handling device.

19. The device stand of claim 13, wherein a configuration of the device stand is modifiable utilizing at least one of: the first pivot point and the second pivot point.

20. A device stand system, the device stand system comprising:
a first information handling device;
a second information handling device; and
a device stand comprising:
a first arm comprising a first pivot point;
a second arm comprising a stand portion and a second pivot point;
a connecting piece connected to one end of the first arm and one end of the second arm; and
an attachment plate located near a second end of the first arm, wherein the attachment plate accepts the first information handling device, wherein the attachment plate couples to the second information handling device.
